(19) United States
(12) Patent Application Publication
(10) Pub. No.: US 2017/0274605 A1
(43) Pub. Date: Sep. 28, 2017

(54) CAP UNIT FOR PUNCTURE REPAIR

(71) Applicant: Sumitomo Rubber Industries, Ltd., Kobe-shi (JP)

(72) Inventor: Yukinori NAGATA, Kobe-shi (JP)

(73) Assignee: Sumitomo Rubber Industries, Ltd., Kobe-shi (JP)

(21) Appl. No.: 15/382,029

(22) Filed: Dec. 16, 2016

(30) Foreign Application Priority Data
Mar. 25, 2016 (JP) 2016-062323

(51) Int. Cl. B29C 73/16; F16K 15/04

(52) U.S. Cl. CPC B29C 73/166; F16K 15/048; F16K 15/044; B60S 5/043

(57) ABSTRACT

A cap unit for puncture repair comprises a check valve 6 for preventing a backflow of a puncture repair liquid supplied from a bottle container 2. The check valve 6 is disposed in a first flow path 3 used for taking compressed air from a compressor 8 into a bottle container 2. The check valve is formed by a ball valve 21 disposed in a valve housing zone Y which is located in a vertical passage part 15 of the first flow path 3 and between an upper opening 3U and a valve seat portion 20. The ball valve 21 is formed by a rubber-like elastic body having a specific gravity of 1.1 or more, and a rebound resilience of 15% or less.

### BACKGROUND OF THE INVENTION

The present invention relates to a cap unit used in a puncture repair kit for injecting a puncture repair liquid and compressed air sequentially into a punctured tire to temporary fix the puncture.

For example, in the following Patent Document 1, a cap unit for puncture repair has been proposed.

This cap unit has, as shown in FIG. 4, a first flow path (a) for taking compressed air supplied from a compressor into a bottle container, and a check valve (b) to prevent a puncture repair liquid from flowing backward.

The check valve (b) comprises a metal ball valve b1 disposed in a valve housing zone (c) formed in the first flow path (a), a rubber valve seat b2 disposed at the lower end of the valve housing zone (c), and a biasing spring b3 for pressing the ball valve b1 against the valve seat b2. Such structure leads to an increase in the cost.

On the other hand, in the following Patent Document 2, a check valve having a simple structure is disclosed, wherein a metal ball valve is inserted in a first flow path provided with a valve seat portion. In this check valve, the valve seat portion is closed by the weight of the ball valve.

In order to retain the ball valve, a locking pin is inserted in the upper end of the first flow path. This structure is simple, and the parts are less in number, therefore, the cost can be reduced.

However, since the ball valve is free to move in the first flow path during storage in a vehicle by the vibrations of the vehicle during traveling, there is a problem such that abnormal noise is caused, making the passenger uncomfortable.

### [Patent Document 1]

Japanese Patent Application Publication No. 2011-189696

### [Patent Document 2]

Japanese Patent Application Publication No. 2010-023244

### SUMMARY OF THE INVENTION

It is, therefore, an object of the present invention to provide a cap unit for puncture repair, in which abnormal noise occurring from a ball valve due to vibrations of the vehicle during traveling can be suppressed, while employing a simple structure to achieve a cost reduction.

According to the present invention, a cap unit for puncture repair comprises:

a cap main body which is attached to a mouth portion of a bottle container containing a puncture repair liquid, and which has a first flow path for taking compressed air from a compressor into the bottle container, and a second flow path for taking out the puncture repair liquid and the compressed air sequentially from the bottle container by the taking-in of the compressed air, and

a check valve which is disposed in the first flow path to prevent a back-flow of the puncture repair liquid supplied from the bottle container,

in a reference attitude of the bottle container whose mouth portion is directed downward, the first flow path has a vertical passage part extending downward from the top opening which opens within the bottle container, and

a valve seat formed in the vertical passage part,

the check valve is a ball valve disposed in a valve housing zone which is formed within the vertical passage part and on the upper side of the valve seat, and

the ball valve is made of a rubber-like elastic material having a specific gravity of 1.1 or more, and a rebound resilience of 15% or less.

In the cap unit for puncture repair according to the present invention, the rubber-like elastic material preferably has a low-temperature-embrittlement temperature of −30 degrees C. or below.

In the cap unit for puncture repair according to the present invention, the ratio Db/Da of the outer diameter Db of the ball valve and an inner diameter Da of the valve housing zone is preferably in the range from 0.75 to 0.9.

In the cap unit for puncture repair according to the present invention, the ratio Db/L of the outer diameter Db of the ball valve and a vertical length L of the valve housing zone is preferably 0.5 or more.

The “specific gravity” is measured in accordance with JIS K6268 “Rubber, vulcanized-Determination of density”.

The “rebound resilience” is measured in accordance with JIS K6255 “Rubber, vulcanized or thermoplastic-Determination of rebound resilience” at a temperature of 23 degrees C.

The “low-temperature-embrittlement temperature” is measured in accordance with JIS K6261 “Rubber, vulcanized or thermoplastic Determination of low temperature properties”, “Low-temperature brittleness test”.

In the cap unit according to the present invention, therefore, as the specific gravity of the ball valve is 1.1 or more, the ball valve can move down in the puncture repair liquid immediately by its own weight and can rapidly close the valve seat, which means that it can function as a check valve without using a biasing spring. Further, the ball valve is formed from the rubber-like elastic body of low repulsion. Therefore, even if the ball valve repeats collisions with the wall of the first flow path due to the vibrations during traveling of the vehicle, abnormal noise is hard to occur and quietness can be ensured.

### BRIEF DESCRIPTION OF THE DRAWINGS

FIG. 1 is a perspective view showing an example of a puncture repair kit employing a cap unit according to the present invention.

FIG. 2 is a cross-sectional view of the cap unit.

FIG. 3(A) is a vertical cross-sectional view showing the check valve in closeup.

FIG. 3(B) is a lateral cross-sectional view showing an locking portion.

FIG. 4 is a cross-sectional view showing the structure of the check valve of the known cap unit.

### DESCRIPTION OF THE PREFERRED EMBODIMENTS

Hereinafter, an embodiment of the present invention will be described in detail.

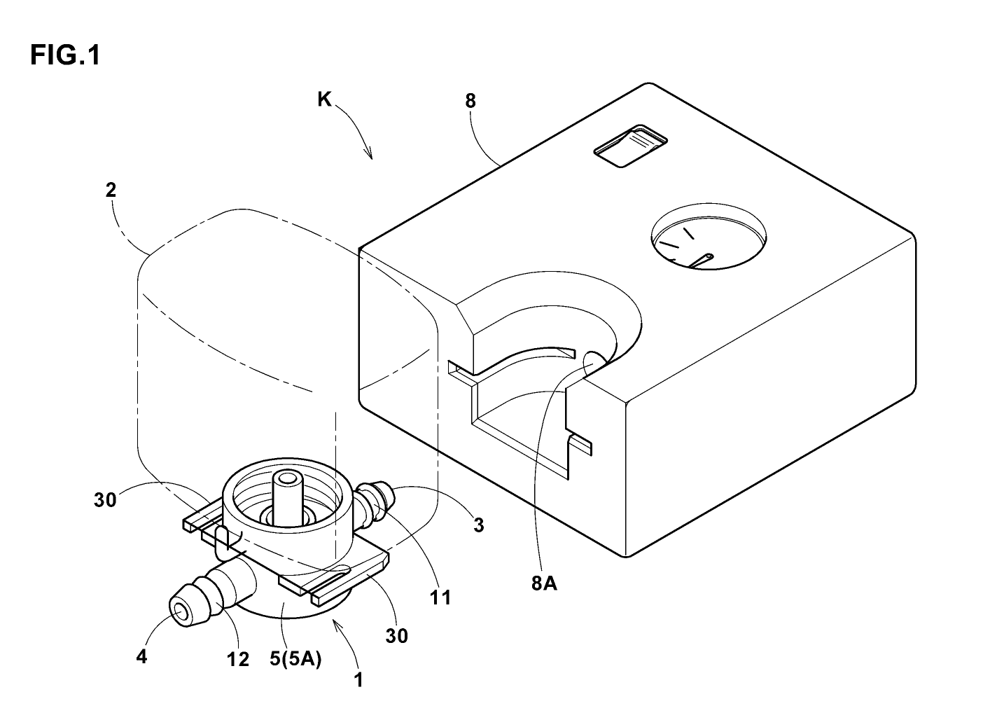

FIG. 1 shows an example of a puncture repair kit K employing a cap unit 1 according to the present invention.

The puncture repair kit K comprises the cap unit 1, a bottle container 2, and a compressor 8 so as to inject a puncture repair liquid and compressed air sequentially into a punctured tire to temporary fix the puncture.

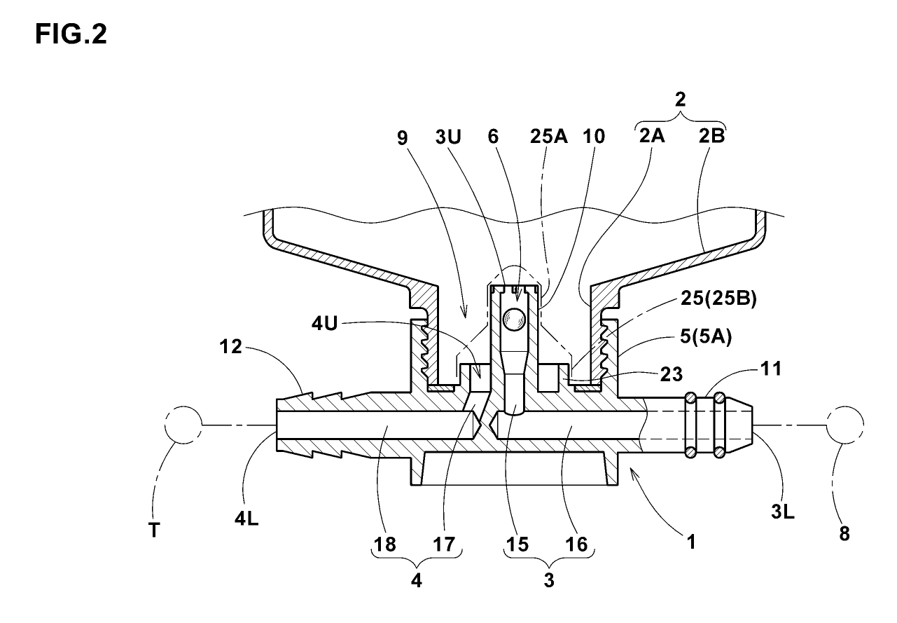

FIG. 2 is a sectional view of the cap unit 1 showing a state in which the bottle container 2 is mounted thereon.

The bottle container 2 has a well-known structure in which a small-diameter cylindrical mouth portion 2A for taking out the puncture repair liquid is protruded from the lower end of the container portion 2B for accommodating the puncture repair liquid.

Hereinafter, the cap unit 1 will be described in its reference attitude such that the mouth portion 2A of the bottle container 2 is directed downward.

As shown in FIG. 2, the cap unit 1 has a cap main body 5 provided with a first flow path 3 and a second flow path 4, and a check valve 6 disposed in the first flow path 3.

The first flow path 3 is for taking the compressed air supplied from the compressor 8 in the bottle container 2.

The second flow path 4 is for taking out the puncture repair liquid and the compressed air sequentially from the bottle container 2 by the taking-in of the compressed air.

The cap main body 5 in this example is provided at the upper end of a cylindrical body portion 5A with a bottle mounting recess 9 for mounting the mouth portion 2A of the bottle container 2.

The inner circumferential surface of the bottle mounting recess 9 is provided with an internal threaded portion to which the mouth portion 2A is attached by being screwed.

In the bottom surface of the bottle mounting recess 9, there are disposed a boss portion 10 extending into the bottle container 2, and an annular rib 23 surrounding the boss portion 10 so that they protrude from the bottom surface.

The boss portion 10 and the annular rib 23 in this example are formed concentrically with the bottle mounting recess 9.

In the outer side surface of the cap main body 5, there are disposed a first connecting portion 11 for the compressor, and a second connecting portion 12 for the tire so that they protrude therefrom.

The first connecting portion 11 in this example is a connection nozzle which can be coupled directly with a compressed air discharge port 8A (shown in FIG. 1) of the compressor 8 without using a hose.

The second connecting portion 12 in this example is a hose connecting portion to which a hose to be connected to the tire T can be connected.

The first flow path 3 has a vertical passage part 15 and a horizontal passage part 16.

The vertical passage part 15 extends downwardly from its upper opening 3U which opens at the upper end of the boss portion 10.

The horizontal passage part 16 extends substantially horizontally from a lower opening 3L which opens at an end of the first connecting portion 11, and intersects the vertical passage part 15 in the form of an L-shape.

The second flow path 4 has a vertical passage part 17 and a horizontal passage part 18.

The vertical passage part 17 extends downwardly from its upper opening 4U which opens in the bottom surface of the bottle mounting recess 9 and between the boss portion 10 and the annular rib 23. The horizontal passage part 18 extends substantially horizontally from a lower opening 4L which opens at an end of the second connecting portion 12, and intersects the vertical passage part 17 in the form of an L-shape.

In the first flow path 3, there is disposed the check valve 6 to prevent the backflow of the puncture repair liquid supplied from the bottle container 2.

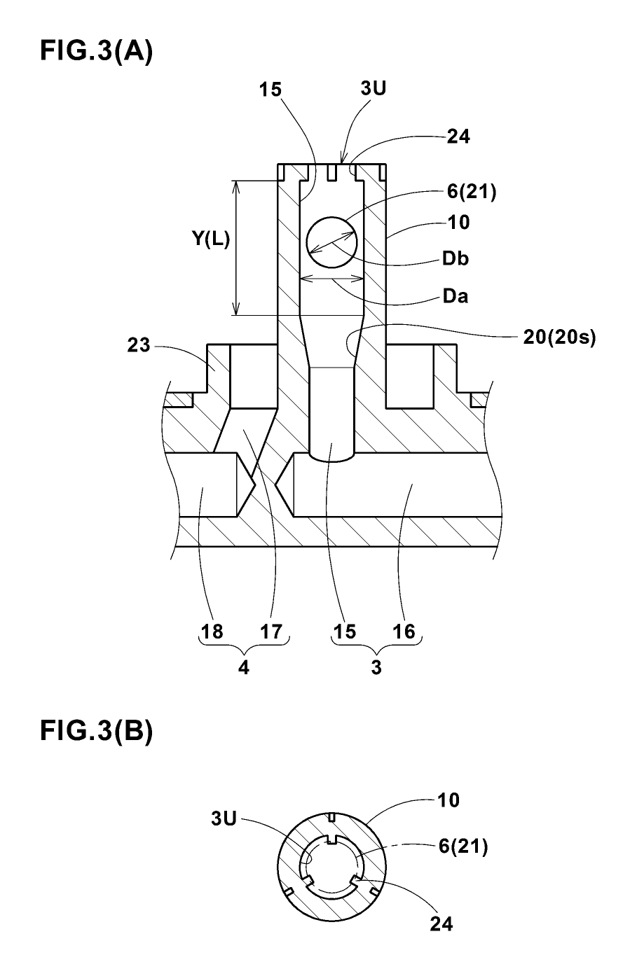

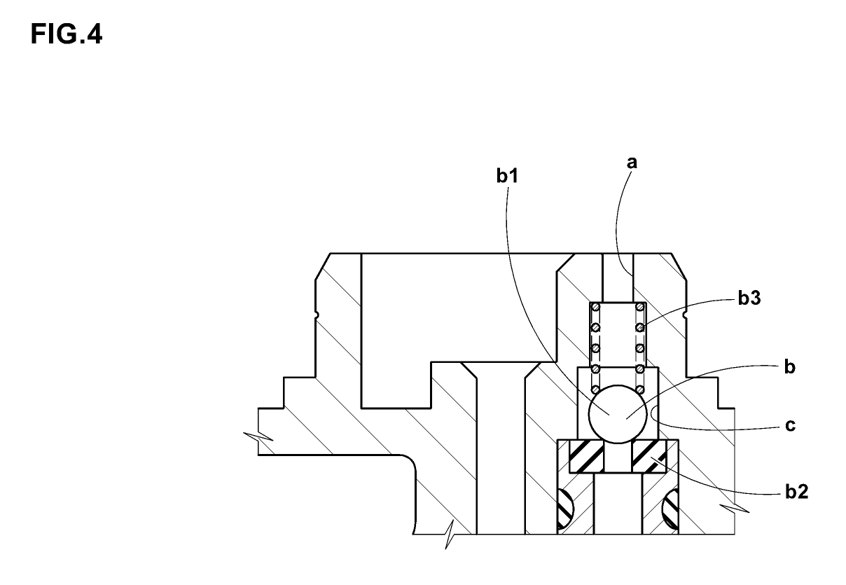

In the vertical passage part 15 of the first flow path 3, as shown in FIG. 3(A), there are disposed a valve seat 20, and a valve housing zone Y located on the upper side of the valve seat.

The valve seat 20 has a cone-shaped valve seat surface 20s whose diameter is reduced toward the lower side.

The check valve 6 is formed by a ball valve 21 disposed in the valve housing zone Y.

The ball valve 21 is placed in the valve housing zone Y loosely to be movable up and down, and can close the valve seat 20 by the down motion due to its own weight.

Thereby, the reverse flow of the puncture repair liquid toward the compressor is prevented.

In this example, the upper opening 3U is provided with a locking portion 24 for preventing the ball valve 21 from falling out therethrough. Accordingly, the valve housing zone Y is formed as a zone between the valve seat 20 and the locking portion 24.

The locking portion 24 is, as shown in FIG. 3(B), formed by a plurality of (eg, three) projections protruding from the inner circumferential surface of the boss portion 10.

In this example, the locking portion 24 is formed by melting the boss portion 10 partially by the use of, for example, a soldering iron or the like after the ball valve 21 has been inserted in the valve housing zone Y.

The ball valve 21 is made of a rubber-like elastic material having a specific gravity of 1.1 or more and a rebound resilience of 15% or less.

The specific gravity of the puncture repair liquid is usually about 1.03, and the ball valve 21 is heavier than the puncture repair liquid. Therefore, when the puncture repair liquid is going to flow back, the ball valve 21 moves down immediately, and it is possible to close the valve seat 20. If the specific gravity is less than 1.1, the downward movement due to its own weight becomes slower, and the backflow of the puncture repair liquid can not be sufficiently prevented. Therefore, it is preferable that the specific gravity is 1.3 or more. The upper limit of the specific gravity is not particularly restricted.

The ball valve 21 is formed by the rubber-like elastic body of low repulsion. Therefore, during storage, even if the ball valve 21 repeats collisions with the wall of the first flow path 3 due to vibrations of the vehicle during traveling, abnormal noise is hard to occur and quietness can be ensured. If the rebound resilience is more than 15%, the occurrence of abnormal noise can not be sufficiently prevented.

Although the lower limit of the rebound resilience is not particularly restricted, it is difficult at present to produce a rubber-like elastic body whose rebound resilience is less than 2%. On the other hand, since the ball valve 21 is formed by the rubber-like elastic body, even if the valve seat 20 is formed from a plastic as a part of the cap main body 5, the sealing can be assured.

As the rubber-like elastic material of low repulsion, butadiene rubber (BR), styrene-butadiene (SBR), butyl rubber (IIR), ethylene-propylene rubber (EPM, EP), ethylene-propylene-diene rubber (EPDM), chloroprene rubber (CR), acrylic rubber (ACM, ANM), chlorosulfonated polyethylene rubber (CSM), silicone rubber (si, Q, VMQ, SR), fluoro rubber (FKM, FRM), epichlorohydrin rubber (CO, ECO) and the like can be used.

There is a tendency that the puncture repair kits K are stored or used in a temperature range of from −30 degrees C. to +60 degrees C. Therefore, it is preferable for the cap unit 1 that the ball valve 21 does not cause brittle fracture at least down to −30 degrees C. Accordingly, as the ball valve 21, the rubber-like elastic body having the low-temperature-embrittlement temperature of under −30 degrees C. is preferably used.

In the check valve 6, it is preferable that the ratio Db/Da of the outer diameter Db of the ball valve 21 and the inner diameter Da of the valve housing zone Y is set in a range of from 0.75 to 0.9.

If the ratio Db/Da is less than 0.75, then the movement of the ball valve 21 in the valve housing zone Y becomes large, and the collision with the wall of the valve housing zone Y becomes strong. Thus, this is disadvantageous for suppressing the generation of abnormal noise.

If the ratio Db/Da is more than 0.9, the flow rate of the high pressure air passing by the ball valve 2 is reduced, and the time required for injecting the puncture repair liquid and increasing the pressure becomes longer, which is disadvantageous to the puncture repair work.

In the check valve 6, it is also preferable that the ratio Db/L between the outer diameter Db of the ball valve 21 and the length L of the valve receiving area Y is 0.5 or more. If the ratio Db/L is less than 0.5, the movement of the ball valve 21 within the valve housing zone Y becomes large, which is disadvantageous for suppressing the generation of abnormal noise.

As shown in FIG. 1, the cap unit 1 is further provided with a guide stopper 30. The housing of the compressor 8 is provided with a slot. At the time of attaching the cap unit 1 to the compressor 8, the guide stopper 30 is inserted in the slot, and as a result, the bottle container 2 is held in the above-mentioned reference attitude by the housing.

As shown in FIG. 2, the cap unit 1 is further provided with an inner lid 25 for preventing the puncture repair liquid from flowing out of the upper openings 3U and 4U before actuating the compressor 8 when the puncture repair kit K has been set up. This inner lid 25 has a first sealing portion 25A and a second sealing portion 25B. The first seal portion 25A hermetically contacts with the outer circumferential surface of the boss portion 10 to thereby seal the upper opening 3U.

The second sealing portion 25B hermetically contacts with the outer circumferential surface of the annular rib 23 to thereby seal the upper opening 4U.

During the puncture repair kit K is operating, the compressed air from the compressor 8 pushes up the inner lid 25, and the inner lid 25 is automatically removed to break the seal.

While detailed description has been made of a particularly preferred embodiment of the present invention, the present invention can be embodied in various forms without being limited to the illustrated embodiment.

### WORKING EXAMPLES

In order to confirm the effects of the present invention, cap units having structures based on the structure shown in FIG. 2 and having the specifications shown in Table 1, were experimentally manufactured, and each of the cap units was tested for the injecting and inflating time, and about whether the puncture repair liquid was flowed backward or not, and whether abnormal noise was generated from the ball valve or not.

The specific gravity, rebound resilience, and low-temperature-embrittlement temperature of the ball valve were changed by changing the rubber-like elastic material.

(1) Injecting and inflating time: using a same compressor, the time required to inject 400 cc of a puncture repair liquid into the tire (195/65R15) and to inflate the tire from zero pressure to 250 kPa was measured. The ambient temperature was −30 degrees C. The results are indicated in Table 1.
(2) whether the puncture repair liquid was flowed backward or not: After the injecting work of the puncture repair liquid was done, the cap unit was removed, and the presence or absence of the reverse flow into the first flow path was visually checked. The results are indicated in Table 1.
(3) whether abnormal noise was generated or not: During traveling in the city streets, each cap unit put on the floor of the rear seat was checked by the driver whether abnormal noise due to the ball valve was generated or not. The results are indicated in Table 1, wherein,
A denotes that abnormal noise was not generated,
B denotes that abnormal noise was slightly generated, and
C denotes that abnormal noise was generated.

TABLE 1

| | Compar- | Compar- | | | Compar- | | | | | |
|---|---|---|---|---|---|---|---|---|---|---|
| | ative | ative | Working | Working | ative | Working | Working | Working | Working | Working |
| | Example | Example | Example | Example | Example | Example | Example | Example | Example | Example |
| | 1 | 2 | 1 | 2 | 3 | 3 | 4 | 5 | 6 | 7 |
| <Ball valve> | | | | | | | | | | |
| specific gravity | 7.8 | 1.0 | 1.1 | 1.1 | 1.1 | 1.1 | 1.1 | 1.1 | 1.1 | 1.1 |
| rebound resilience (%) | — | 4 | 4 | 4 | 20 | 4 | 15 | 10 | 13 | 6 |
| material | SUS | IIR | IIR | IIR | BR | IIR | BR | SBR | VMQ | FKM |
| low-temperature- | — | −40 | −40 | −40 | −40 | −40 | −60 | −30 | −80 | −30 |
| embrittlement | | | | | | | | | | |
| temperature (deg. C.) | | | | | | | | | | |
| outer diameter Db (mm) | 3.5 | 3.5 | 2.8 | 3.5 | 3.5 | 3.8 | 3.5 | 3.5 | 3.5 | 3.5 |
| inner diameter Da | 4.0 | 4.0 | 4.0 | 4.0 | 4.0 | 4.0 | 4.0 | 4.0 | 4.0 | 4.0 |
| of valve housing | | | | | | | | | | |
| zone (mm) | | | | | | | | | | |
| length L of valve | 6.0 | 6.0 | 6.0 | 6.0 | 6.0 | 6.0 | 6.0 | 6.0 | 6.0 | 6.0 |
| housing zone (mm) | | | | | | | | | | |
| ratio Db/Da | 0.88 | 0.88 | 0.70 | 0.88 | 0.88 | 0.95 | 0.88 | 0.88 | 0.88 | 0.88 |
| ratio Db/L | 0.58 | 0.58 | 0.47 | 0.58 | 0.58 | 0.63 | 0.58 | 0.58 | 0.58 | 0.58 |
| injecting and | 780 | 765 | 760 | 775 | 770 | 910 | 760 | 765 | 770 | 760 |
| inflating time | | | | | | | | | | |
| presence or absence | absence | presence | absence | absence | absence | absence | absence | absence | absence | absence |
| of backward flow | | | | | | | | | | |
| abnormal noise | C | A | B | A | C | A | A | A | A | A |
| generation | | | | | | | | | | |

As shown in Table, it was confirmed that, in the working examples, abnormal noise generated from the ball valve due to vibrations of the vehicle during traveling can be effectively suppressed.

### DESCRIPTION OF THE SIGNS

1 cap unit
2 bottle container
2A mouth portion
3 first flow path
3U opening
4 second flow path
cap main body
6 check valve
8 compressor
vertical passage part
valve seat
21 ball valve
Y valve housing zone

1. A cap unit for puncture repair comprising:
a cap main body which is attached to a mouth portion of a bottle container containing a puncture repair liquid, and which has a first flow path for taking compressed air supplied from a compressor into the bottle container, and a second flow path for taking out the puncture repair liquid and the compressed air sequentially from the bottle container by the taking-in of the compressed air, and
a check valve which is disposed in the first flow path to prevent a back-flow of the puncture repair liquid supplied from the bottle container,
in a reference attitude of the bottle container whose mouth portion is directed downward, the first flow path has a vertical passage part extending downward from its top opening which opens within the bottle container, and a valve seat formed in the vertical passage part,
the check valve is a ball valve disposed in a valve housing zone which is formed in the vertical passage part and on the upper side of the valve seat, and
the ball valve is made of a rubber-like elastic material having a specific gravity of 1.1 or more, and a rebound resilience of 15% or less.

2. The cap unit for puncture repair as set forth in claim 1, wherein the ball valve has a low-temperature-embrittlement temperature of −30 degrees C. or below.

3. The cap unit for puncture repair as set forth in claim 1, wherein the ratio Db/Da of the outer diameter Db of the ball valve and an inner diameter Da of the valve housing zone is in a range from 0.75 to 0.9.

4. The cap unit for puncture repair as set forth in claim 2, wherein the ratio Db/Da of the outer diameter Db of the ball valve and an inner diameter Da of the valve housing zone is in a range from 0.75 to 0.9.

5. The cap unit for puncture repair as set forth in claim 1, wherein the ratio Db/L of the outer diameter Db of the ball valve and a length L of the valve housing zone is 0.5 or more.

6. The cap unit for puncture repair as set forth in claim 2, wherein the ratio Db/L of the outer diameter Db of the ball valve and a length L of the valve housing zone is 0.5 or more.

7. The cap unit for puncture repair as set forth in claim 3, wherein the ratio Db/L of the outer diameter Db of the ball valve and a length L of the valve housing zone is 0.5 or more.
